(19) United States
(12) Patent Application Publication
(10) Pub. No.: US 2023/0389203 A1
(43) Pub. Date: Nov. 30, 2023

(54) TARGET DEVICE, METHOD FOR SUPPRESSING RESONANCE RESPONSE OF TARGET DEVICE AND COMPUTER-READABLE STORAGE MEDIUM

(71) Applicant: Lenovo (Beijing) Limited, Beijing (CN)

(72) Inventors: Hao NI, Beijing (CN); Xiaohong YANG, Beijing (CN)

(21) Appl. No.: 18/325,672

(22) Filed: May 30, 2023

(30) Foreign Application Priority Data
May 30, 2022 (CN) 202210605400.X

(51) Int. Cl. H05K 5/02; F16F 15/00

(52) U.S. Cl. CPC H05K 5/0217; F16F 2238/04; F16F 15/00

(57) ABSTRACT

A target device includes: a first tray located at a bottom of the target device; at least one second tray located above the first tray; and a damping resonator detachably installed in the first tray. A resonance frequency acquisition device is disposed in the at least one second tray configured to obtain a target resonance frequency of the target device, and the damping resonator is configured to suppress a resonance response of the target device at the target resonance frequency.

### CROSS-REFERENCE TO RELATED APPLICATION

This application claims priority to Chinese Patent Application No. 202210605400.X, filed with the China National Intellectual Property Administration (CNIPA) on May 30, 2022, the entire contents of all of which are incorporated herein by reference.

### TECHNICAL FIELD

The present disclosure relates to the technical field of communications and, more particularly, to a target device, a method for suppressing a resonance response of the target device, and a computer-readable storage medium.

### BACKGROUND

When transporting computing equipment, due to complicated transportation conditions, vibration incident waves are often generated by vehicles, and road surfaces, etc. When the vibration incident waves are in a specific frequency range, the vibration incident waves resonate with the transported computing equipment to cause damages to equipment structures and result in immeasurable economic damage and reputation loss. In related technologies, cushion materials are added to packaging of the computing equipment to increase cushion performance of the packaging. But this approach cannot fundamentally solve the problem of vibration energy transmission, and the cushion materials obviously add to equipment cost.

### SUMMARY

One aspect of the present disclosure provides a target device. The target device includes a first tray located at a bottom of the target device; at least one second tray located above the first tray; and a damping resonator detachably installed in the first tray. A resonance frequency acquisition device is disposed in the at least one second tray configured to obtain a target resonance frequency of the target device, and the damping resonator is configured to suppress a resonance response of the target device at the target resonance frequency.

Another aspect of the present disclosure provides a method for suppressing resonance response of a target device. The method includes: obtaining a target resonance frequency of the target device; and suppressing the resonance response of the target device at the target resonance frequency through a damping resonator.

Another aspect of the present disclosure provides computer-readable storage medium storing one or more programs. The one or more programs are executed by one or more controllers to perform: obtaining a target resonance frequency of a target device; and suppressing a resonance response of the target device at the target resonance frequency through a damping resonator.

### BRIEF DESCRIPTION OF THE DRAWINGS

FIG. 1 is a schematic diagram showing composition of an exemplary target device according to some embodiments of the present disclosure;

FIG. 2 is a schematic diagram showing composition of an exemplary resonance frequency acquisition device according to some embodiments of the present disclosure;

FIG. 3 is a schematic structural diagram of an exemplary damping resonator according to some embodiments of the present disclosure;

FIG. 4 is a flowchart of an exemplary method for suppressing resonance response according to some embodiments of the present disclosure;

FIG. 5 is a schematic structural diagram of an exemplary target device according to some embodiments of the present disclosure;

FIG. 6 is a schematic structural diagram of another exemplary damping resonator according to some embodiments of the present disclosure; and

FIG. 7 is a response comparison curve of target resonance frequencies before and after a damping resonator is installed in a target device according to some embodiments of the present disclosure.

### DETAILED DESCRIPTION OF THE EMBODIMENTS

In order to make the objectives, technical solutions, and advantages of the present disclosure clearer, the present disclosure will be further described in detail below with reference to the accompanying drawings. Obviously, the described embodiments are only some of the embodiments of the present disclosure, not all of the embodiments. Based on the embodiments of the present disclosure, all other embodiments obtained by those of ordinary skill in the art without creative efforts shall fall within the scope of the present disclosure.

Various methods for suppressing resonance in related technologies are described below.

Resonance refers to a phenomenon that an amplitude of a mechanical system increases significantly when an excitation frequency of the mechanical system is close to an intrinsic frequency of the mechanical system. When a target device is transported, resonance response is mainly a single frequency response. The resonance response is caused by a coupling of road excitation and vehicle excitation during transportation. This type of excitation sources includes broadband multi-frequency component excitation. Frequency components in input excitation that can be coupled with a response frequency of the target device need to be reduced to reduce the resonance response of the target device during transportation.

A principle of local resonance is to attach a damping resonator with a specified resonant frequency to the target device. Due to a mutual coupling between its own resonance characteristics and an incident elastic wave, the damping resonator may block propagation of the incident elastic wave in a body of the target device and form a local resonance bandgap, which can effectively reduce the resonance response of the target device in the response frequency of the target device by the damping resonator.

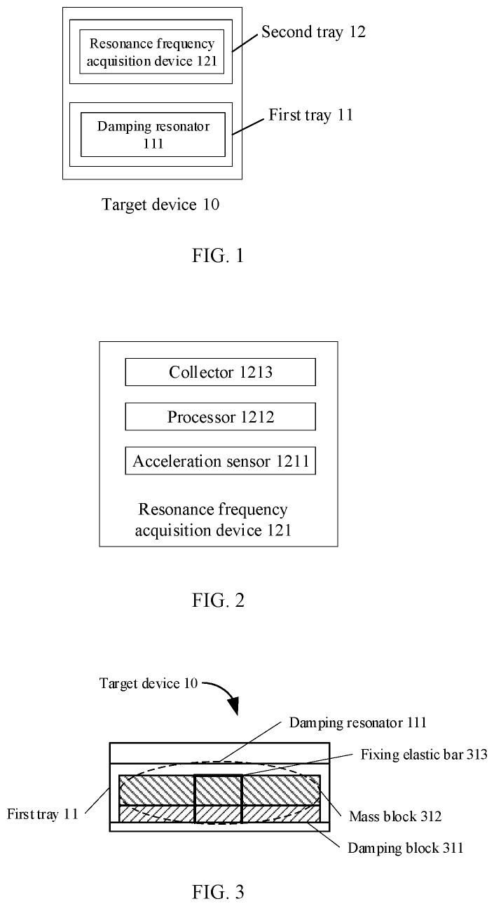

The present disclosure provides a target device. FIG. 1 is a schematic diagram showing composition of an exemplary target device according to some embodiments of the present disclosure. As shown in FIG. 1, the target device 10 includes a first tray 11 near a bottom of the target device 10, at least one second tray 12 located above the first tray 11, and a damping resonator 111 detachably installed in the first tray 11. A resonance frequency acquisition device 121 is disposed in the at least one second tray 12. The resonance frequency acquisition device 121 is configured to collect a target resonance frequency of the target device. The damping resonator 111 is configured to suppress the resonance response of the target device 10.

In some embodiments, the target device may be an entire server cabinet, electronic equipment such as a laptop computer, a desktop computer, a projector, and a camera, or household appliances such as a refrigerator and an air conditioner, which are not limited by the present disclosure herein.

Resonance refers to a situation where a physical system vibrates at a specific frequency with a greater amplitude than other frequencies. The specific frequency is called the resonance frequency. The target resonance frequency refers to a frequency at which the resonance is likely to occur between the target device and an incident wave (e.g., an incident elastic wave). For example, when the target device is the entire server cabinet, the incident wave due to the coupling of the road excitation/vehicle excitation may resonate with the target device during transportation. Then, the target resonance frequency at which the target device resonates with the incident wave needs to be determined. When the target device is excited externally to produce the resonance response, a frequency of the external excitation is the same or substantially close to an intrinsic frequency of the entire server cabinet, and the frequency at which the resonance response occurs is the target resonance frequency.

In some embodiments, the damping resonator is installed in the first tray near the bottom of the target device. When the incident elastic wave due to the vehicle/road excitation is transmitted, it first encounters the damping resonator located at the bottom of the target device. Due to its own resonance characteristics, the damping resonator may couple with the incident elastic wave to block the propagation of the incident elastic wave in the body of the target device, form the local resonance bandgap, and effectively reduce the vibration of the target device within a frequency range of the resonance bandgap.

In some embodiments, the first tray 11 in the target device 10 is slidably connected to the target device 10 through slide rails.

FIG. 2 is a schematic diagram showing composition of an exemplary resonance frequency acquisition device according to some embodiments of the present disclosure. As shown in FIG. 2, the resonance frequency acquisition device 121 includes: an acceleration sensor 1211, a processor 1212, and a collector 1213. The acceleration sensor 1211 is configured to measure an acceleration over time curve of the target device 10. The processor 1212 is configured to perform Fourier transform processing on the acceleration over time curve to obtain a power spectral density (PSD) curve.

The collector 1213 is configured to collect a peak frequency on a PSD curve to obtain the target resonance frequency of the target device 10.

In some embodiments, the target resonance frequency of the target device is collected by the resonance frequency acquisition device installed in the at least one second tray.

FIG. 3 is a schematic structural diagram of an exemplary damping resonator according to some embodiments of the present disclosure. As shown in FIG. 3, the damping resonator 111 located in the first tray 11 includes: a damping block 311, a mass block 312, and a fixed elastic bar 313. The damping block 311 is configured to provide a stiffness parameter of the damping resonator. The damping block may be made of damping materials such as rubber, plastic, and foam.

The mass block 312 is configured to provide a mass parameter of the damping resonator. An intrinsic frequency of the damping resonator may be determined based on the stiffness parameter and the mass parameter.

One end of the fixed elastic bar 313 is fixedly installed on a bottom plate of the first tray 11, and the other end is configured to fix the damping block 311 and the mass block 312 in the first tray 11.

In some embodiments, one end of the fixed elastic bar 313 passes through a hole provided on the bottom plate of the first tray 11, and is connected to the bottom plate of the first tray 11 by bolts to provide a pre-tightening force. The other end is disposed at the mass block 312 to fix the mass block 312 and the damping block 311 under the mass block 312 to the first tray 11 through the pre-tightening force.

At the target resonance frequency, when the target device is excited by external incident waves, large-amplitude vibrations may occur. This is extremely unfavorable during the transportation of the target device, and it is likely that structures of the target device may be damaged due to the resonance, resulting in losses. In some embodiments, the damping resonator is added to the target device, and the damping resonator is prioritized to resonate with the incident elastic wave at the target resonance frequency to suppress the resonance response of the target device at the target resonance frequency.

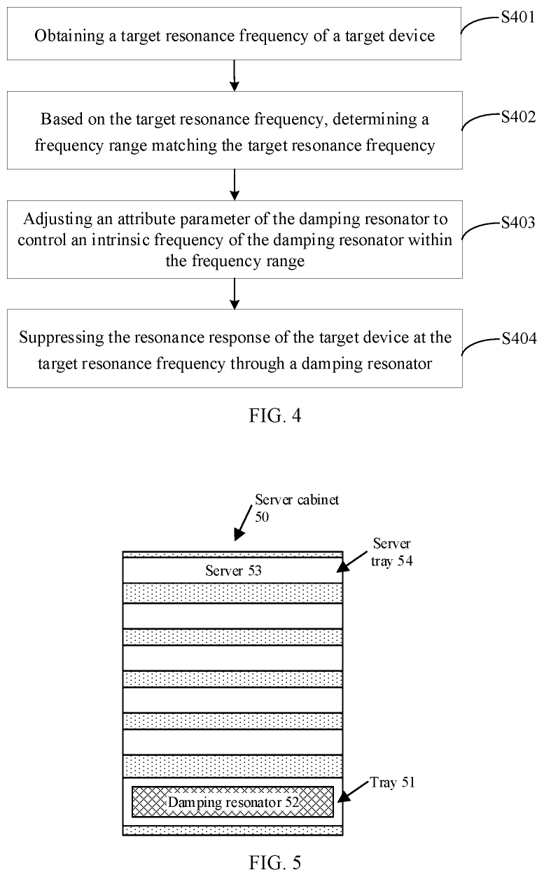

The present disclosure also provides a method for suppressing resonance response. The method can be applied to the above-described target device. FIG. 4 is a flowchart of an exemplary method for suppressing resonance response according to some embodiments of the present disclosure. As shown in FIG. 4, the method includes the following processes.

At S401, a target resonance frequency of the target device is obtained.

To suppress the resonance response of the target device, it is necessary to obtain the target resonance frequency of the target device first. The target resonance frequency of the target device may be collected through the resonance frequency acquisition device installed in the at least one second tray during the transportation or under specific vibration conditions. In some embodiments, the resonance frequency acquisition device includes the acceleration sensor, the processor, and the collector. S401 further includes the following processes.

At S4011, an acceleration over time curve of the target device is obtained through measurements.

During the transportation process, the target device will generate the resonance response in response to road surface excitation. The acceleration sensor and the target device move together. Acceleration of the target device can be obtained through the measurements by the acceleration sensor, and then the acceleration over time curve can be obtained by calculating a functional relationship between the acceleration and time.

At S4012, a Fourier transform processing is performed on the acceleration over time curve to obtain the PSD curve.

In some embodiments, the processor performs the Fourier transform processing on the acceleration over time curve obtained in S4011 to obtain the PSD curve.

At S4013, the peak frequency on the PSD curve is collected to obtain the target resonance frequency of the target device.

In some embodiments, the peak frequency is read on the PSD curve by the collector as the target resonance frequency of the target device.

At S402, based on the target resonance frequency, a frequency range matching the target resonance frequency is determined.

In some embodiments, because a resonance frequency of the incident wave is close to the target resonant frequency of the target device, the frequency range matching the target resonance frequency can be determined according to the target resonance frequency.

In some embodiments, S402 may be further implemented through the following processes.

At S4021, a frequency adjustment threshold is obtained. The frequency adjustment threshold here may be pre-configured by a technician. For example, the frequency adjustment threshold may be configured to be 10%.

At S4022, a difference between the target resonance frequency and the frequency adjustment threshold is determined to be a lower limit, and a sum of the target resonance frequency and the frequency adjustment threshold is determined to be an upper limit.

At S4023, a frequency range between the lower limit and the upper limit is determined to be the frequency range matching the target resonance frequency.

In some embodiments, the frequency range matching the target resonance frequency is determined by determining the frequency adjustment threshold, and the determined frequency range becomes a design range of the intrinsic frequency of the damping resonator. The intrinsic frequency of the damping resonator is designed to be within the frequency range matching the target resonance frequency, such that when the incident wave at a frequency near the target resonance frequency enters the target device, the incident wave may be absorbed by the damping resonator first to suppress the target device resonance response.

In some embodiments, the target resonance frequency includes a plurality of target resonance frequencies. Correspondingly, obtaining the frequency adjustment threshold in S4021 further includes the following processes.

At step A, a frequency adjustment value record table is obtained. The frequency adjustment value record table includes mapping relationship between resonance frequencies and target frequency adjustment values respectively.

At step B, a target frequency adjustment value having the mapping relationship with each target resonance frequency of the plurality of target resonance frequencies is determined from the frequency adjustment value record table.

At step C, a maximum target frequency adjustment value among the target frequency adjustment values corresponding to the plurality of target resonance frequencies is determined to be the frequency adjustment threshold.

In some embodiments, the target device has the plurality of target resonant frequencies, that is, the target device may resonate at the plurality of target resonant frequencies. At this time, the target frequency adjustment value corresponding to each target resonant frequency is determined through the frequency adjustment value record table. The target frequency adjustment values are sorted, and the maximum target frequency adjustment value among them is determined to be the frequency adjustment threshold. Then, the difference between the target resonance frequency and the frequency adjustment threshold is determined to be the lower limit, and the sum of the target resonance frequency and the frequency adjustment threshold is determined to be the upper limit. The range between the lower limit value and the upper limit is determined to be the frequency range matching the target resonance frequency.

At S403, attribute parameters of the damping resonator are adjusted such that the intrinsic frequency of the damping resonator is within the frequency range.

In some embodiments, the attribute parameters of the damped resonator include the mass parameter and the stiffness parameter. By adjusting the mass parameter and the stiffness parameter, the intrinsic frequency of the damping resonator can meet the frequency range.

The mass parameter of the mass block and/or the stiffness parameter of the damping block may be adjusted according to formula (1) to control the intrinsic frequency of the damping resonator within the frequency range:

$$2 πω = \sqrt{\frac{k}{m}} , \qquad ( 1 )$$

where, k is the stiffness parameter, m is the mass parameter, and ω is the intrinsic frequency of the damping resonator.

For example, the target resonance frequency of the target device is obtained to be 20 Hz. At this time, the target resonance frequency of 20 Hz is used to determine the frequency adjustment threshold to be 10%, and the frequency range between 18 Hz and 22 Hz is obtained. Thus, the intrinsic frequency of the damping resonator is designed such that the intrinsic frequency of the damping resonator is in the frequency range, that is, the intrinsic frequency ω satisfies ω⊂[18,22].

In some embodiments, when designing the intrinsic frequency ω of the damping resonator through the formula (1), the mass parameter m of the mass block is confirmed to accommodate the mass block in the design of the first tray. For example, the mass parameter m is 15 kg, and the stiffness parameter k of the damping block can be calculated from the formula (1) in the range of [191865, 286613]. The stiffness parameter is adjusted to an appropriate value, such that the intrinsic frequency of the damping resonator meets the design requirements.

In some embodiments, the stiffness parameter includes a size parameter and a hardness parameter. The stiffness parameter of the damping block may be determined based on the size parameter and the hardness parameter. That is, after determining the value of the stiffness parameter k, the size and hardness of the damping block may be selected according to the required stiffness parameter, such that the intrinsic frequency of the damping resonator meets the design requirements of the frequency range.

In some embodiments, the size and hardness of the damping block that can be accommodated in the first tray may be confirmed first, and the stiffness parameter of the damping block can be determined through the selected size and hardness of the damping block. A range of the mass parameter of the mass block may be calculated by formula (1). The mass parameter may be adjusted to the appropriate value accordingly, such that the intrinsic frequency of the damping resonator meets the design requirements.

In some embodiments, the mass parameter and the stiffness parameter may also be adjusted at the same time, such that the mass parameter and the stiffness parameter satisfy the formula (1).

At S404, the resonant response of the target device at the target resonant frequency is suppressed by the damping resonator.

In some embodiments, the intrinsic frequency of the damping resonator is designed by adjusting the attribute parameters of the damping resonator, such that the intrinsic frequency of the damping resonator matches the target resonance frequency, and the damping resonator whose designed intrinsic frequency matches the target resonance frequency is installed in the first tray located close to the bottom of the target device. During the process of transporting the target device, when the road excitation and/or vehicle excitation on the transportation road are close to the target resonance frequency of the target device, the resonance response may occur. The incident wave generated by the road excitation and/or the vehicle excitation may first propagate to the damping resonator located at the bottom of the target device, and the incident wave may be absorbed by the damping resonator whose intrinsic frequency matches the target resonance frequency, thereby forming a local resonance bandgap in the damping resonator to suppress the resonance response of the target device.

In some embodiments, the target resonance frequency at which the target device is likely to resonate is obtained. The frequency adjustment threshold is calculated to determine the frequency range. The designed frequency range of the intrinsic frequency of the damping resonator is obtained. The stiffness parameter and/or the mass parameter of the damping resonator is adjusted such that the intrinsic frequency of the damping resonator falls into the frequency range. The damping resonator whose intrinsic frequency matches the target resonance frequency is installed in the first tray located close to the bottom of the target device. The damping resonator absorbs the incident elastic wave at the target resonance frequency based on the principle of local resonance, and suppresses the resonance response of the target device. Thus, an objective of protecting the target device is achieved, a transportation risk of the target device is reduced, and an anti-vibration capability is improved.

The method for suppressing the resonance response provided in the embodiments of the present disclosure may be applied to the following scenarios.

In a transportation scenario, the target device including a server cabinet is being transported. Due to a complicated situation during the transportation, the incident wave generated by vibrations of the road surface, vehicles, etc. may resonate with the server cabinet to cause the target device to move with large amplitudes, thereby causing structural damages to the target device, and hence large economic losses.

In an anti-seismic scenario, when the target device is being transported to a server room, the target device needs to meet certain anti-seismic requirements when the target device is installed. Therefore, more and more server room constructions now require the target device to support an anti-seismic design, which is a challenge for a structural design of the target device.

In the above scenarios, the target device may be produced by different manufacturers with different requirements, which may not fully meet the seismic design requirements. Therefore, in some embodiments, the damping resonator is designed for the target device and is retrofitted as an add-on module to the target device to absorb the vibrations generated during transportation, reduce transportation risks, improve the anti-seismic capability of the target device during operation, and meet the anti-seismic requirements of the server room.

The embodiments of the present disclosure will be described in detail below in an actual application scenario.

Currently, the biggest risk in a server delivery process is the transportation of the entire server cabinet. The server cabinet has a high value, and the transportation situation is complicated. If the vibrations during the transportation causes structural damages to the server cabinet, which in turn causes damages to server nodes, resulting economic and reputational losses are hard to estimate. At the same time, more and more server room constructions now require the anti-seismic design of servers, which is a big challenge to the structural design of the servers. In addition, the servers also need to be accommodated by cabinets from various manufacturers. Design requirements of the cabinets by the various manufacturers vary from time to time and may not be able to fully meet the anti-seismic design requirements.

In one exemplary solution, cushion material may be added to a package to increase cushion performance of the package. The disadvantage of this solution is as follows. The packaging material is disposable and will be discarded after use. Higher cost of the packaging may reduce a product profit. Further, the cushion material of the packaging is not environmentally friendly, thereby harmful to the environment.

In another exemplary solution, brackets or other redundant structural designs may be added for relatively less sturdy servers, such that individual server is strengthened to mitigate the transportation risk. The brackets may be removed after the servers are transported to a destination thereof. The disadvantages of this solution are a s follows. The brackets are designed for the individual server, and may not be generally applicable to different servers. General applicability of the brackets makes the bracket design difficult. The brackets need to be installed at each server, and need to be removed after the servers reach their destination. The cost of product design and production may be increased. After the brackets are removed, the server itself may not meet the anti-seismic design requirements for the server room.

In view of the above problems and the disadvantages of the existing solutions, the present disclosure provides a modularized local resonance-based damping resonator that can effectively absorb transportation and seismic vibrations for commonly available standard size cabinets. When the servers need to meet the anti-seismic requirements for the server room or the cabinets are provided by different manufacturers, the damping resonator may be added to the cabinets as a single module to absorb the transportation vibration, reduce the transportation risk, and improve server anti-seismic ability.

When the server is transported in the entire cabinet, the resonance response is mainly a single frequency response. The resonance response is caused by the coupling of the road excitation/vehicle excitation during the transportation. This type of excitation source includes the broadband multi-frequency component excitation. If the frequency components in the input excitation coupled with the server response frequency is reduced, the resonance response of the server during the transportation can be significantly reduced.

The principle of local resonance is to attach the damping resonator with a specified resonance frequency to the structure. Due to a mutual coupling between its own resonance attribute and the incident elastic wave, the damping resonator may block the propagation of the incident elastic wave in the body and form the local resonance bandgap. The frequency range of the local resonance bandgap is closely related to the resonance frequency of the damping resonator. Thus, as long as a frequency attribute of the damping resonator is reasonably designed, the vibration of the body in the frequency range of the local resonance bandgap can be effectively reduced.

Based on the above analysis, the present disclosure provides a server cabinet. FIG. 5 is a schematic structural diagram of an exemplary target device according to some embodiments of the present disclosure. As shown in FIG. 5, the server cabinet 50 (i.e., the target device) includes a tray 51 (namely the first tray) for installing the damping resonator and capable of being directly fixed to sliding guide rails of the server cabinet by screws, a damping resonator 52 detachably installed in the tray 51 to absorb the incident elastic wave, and a plurality of servers 53 located in a plurality of server trays 54, respectively. In some embodiments, the tray 51 in which the damping resonator 52 is installed is located under the plurality of server trays 54, that is, the tray 51 is located at a bottom of the server cabinet 50.

In some embodiments, a frequency acquisition device (not shown) may also be installed in the plurality of server trays 54 for obtaining the target resonance frequency at which the server cabinet exhibits the resonance response during the transportation.

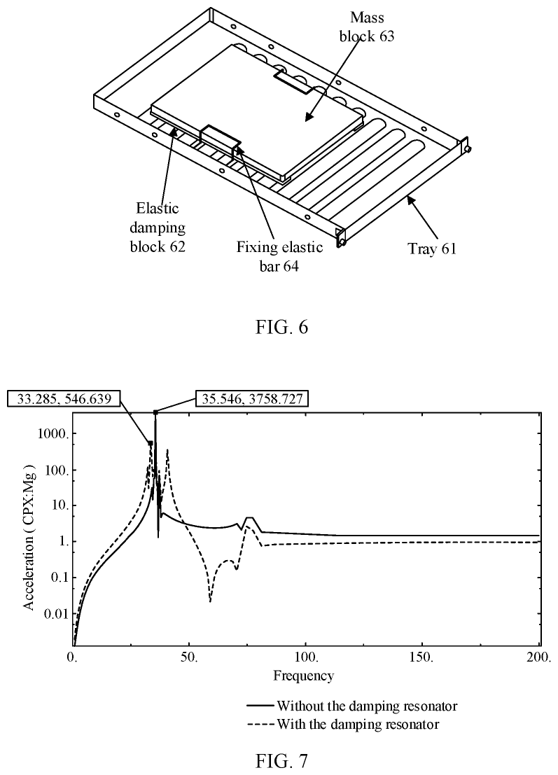

FIG. 6 is a schematic structural diagram of another exemplary damping resonator according to some embodiments of the present disclosure. As shown in FIG. 6, a damping resonator is installed in a tray 61. The damping resonator includes an elastic damping pad 62 (i.e., damping block) configured to provide an elasticity and damping parameter (i.e., stiffness parameter) of the resonance damper, a mass block 63 configured to provide a mass parameter, and a fixing elastic bar 64 configured to fix the mass block 63 and the elastic damping pad 62 to the tray 61 and provide a pre-tightening force. The elastic damping pad 62 may be made of rubber.

In some embodiments, the damping resonator is added to the server cabinet. Due to the mutual coupling between the resonance attribute of the damping resonator and the incident elastic wave, the damping resonator blocks the propagation of the incident elastic wave in the body of the server cabinet and forms the local resonance bandgap. The frequency range of the local resonance bandgap is closely related to the resonance frequency of the damped resonator. Thus, as long as the intrinsic frequency of the damping resonator is reasonably designed, the resonance response of the body of the server cabinet within the frequency range of the local resonance bandgap can be effectively reduced.

Based on the above analysis, the present disclosure also provides a method for suppressing the resonance response. The method may be applied to the above-described target device. The method includes the following processes. Firstly, a resonance frequency (i.e., target resonance frequency) for a server (i.e., target devices) during transportation is measured, and an acceleration over time curve of the server is measured by an acceleration sensor installed in the server. A PSD curve of an installation position of the acceleration sensor may be obtained through Fourier transformation process. The resonance frequency of the server (i.e., server node) may be obtained by calculating a peak frequency of the PSD curve.

Secondly, based on the resonance frequency (i.e., target resonance frequency) measured at the server, the intrinsic frequency of the damping resonator may be designed to match the resonance frequency. The stiffness of the rubber pad (i.e., the stiffness parameter) and the mass of the mass block (i.e., the mass parameter) of the damping resonator may be adjusted, such that the intrinsic frequency of the damping resonator differs from the resonance frequency of the server by less than the frequency range (e.g., 10%). Based on the resonance frequency of the server, the formula (1) may be used to design the mass block that can be accommodated first, such as 15 kg. Further, based on the resonance frequency (i.e., required design frequency) measured at the server, for example, 20 Hz, the formula (1) may be used again to calculate the required stiffness of the rubber pad. Based on the required stiffness, a shape and hardness of the rubber pad may be designed to achieve the required design frequency of the damping resonator.

Finally, when the entire server cabinet needs to be transported, the damping resonator with the required design frequency is installed at the bottom of the server cabinet, and occupies a standard rack space.

In some embodiments, the standard rack space of the server cabinet is 1 U, and 1 U means that the height of the standard rack space is 1.75 inches.

By installing the damping resonator in the server cabinet, the vibration and impact intensity of the server during the transportation of the server cabinet can be reduced, and the cost and complexity of a structural design and a packaging design of the server cabinet can be reduced. Further, due to a universal 1 U/2 U design, the damping resonator may be applied to most standardized cabinets. Even if servers from different manufacturers are installed in these cabinets, the damping resonator may still be installed to reduce the transportation risk and the packaging cost of the server cabinet. Thus, the resonance response of the server cabinet can be significantly reduced.

The finite element method is used to calculate responses of a server cabinet model at given frequency sweep load excitation, and the results are shown in Table 1 below.

TABLE 1
Response comparison values at the target resonance
frequency with or without the damping resonator

| | Response effective | Response peak |
|---|---|---|
| | value m/s² | value m/s² |
| Without the damping | 0.197 | 3.758 |
| resonator | | |
| With the damping resonator | 0.154 | 0.546 |
| Reduction | ~22% | ~84% |

It can be seen from Table 1 that after the damping resonator is installed in the server cabinet, the response peak value is reduced by about 84% compared with that of the server cabinet without the damping resonator, and the response effective value in a full frequency band is reduced by about 22%, indicating that after installing the damping resonator in the server cabinet, the vibration intensity of the server is effectively reduced and the server is protected.

FIG. 7 is a response comparison curve of target resonance frequencies before and after a damping resonator is installed in a target device according to some embodiments of the present disclosure. As shown in FIG. 7, before the damping resonator is installed, the target device has the frequency range of 30-40 Hz and the response peak value of 3758.727. After the damping resonator is installed, the target device has the frequency range of 30-40 Hz, and the response peak value reduced to 546.639. As shown in FIG. 7, after the damping resonator is installed, the response peak value of the target device at the target resonance frequency is significantly reduced. The damping resonator effectively absorbs the incident wave at the target resonance frequency and reduces the resonance response of the target device.

In the embodiments of the present disclosure, the target resonance frequency of the target device is determined. The frequency range that needs to be satisfied for designing the intrinsic frequency of the damping resonator is determined. By adjusting the stiffness parameter and the mass parameter of the damping resonator, the intrinsic frequency of the damping resonator can be designed to meet the design requirements. During the transportation process, the damping resonator having the intrinsic frequency meeting the design requirements is installed at the bottom of the target device, such that the incident elastic wave resonates with the damping resonator, and forms the local resonance bandgap to absorb the transportation vibration and to suppress the resonance response of the target device, thereby reducing the transportation risk, improving the anti-vibration capability of the target device, and protecting the target device from being damaged.

The present disclosure also provides a computer-readable storage medium. The computer storage medium stores one or more programs. The one or more programs may be executed by one or more controllers to implement the following processes. Each of the one or more controllers may be a microprocessor, a microcontroller, a central processing unit (CPU), a digital signal processor (DSP), a field programmable gate array (FPGA), or an application specific integrated circuit (ASIC). The target resonance frequency of the target device is obtained. The resonance response of the target device at the target resonant frequency is suppressed by the damping resonator.

In some embodiments, the one or more programs may be executed by one or more processors to implement the following processes. Based on the target resonance frequency, the frequency range matching the target resonance frequency is determined. The attribute parameters of the damping resonator are adjusted, such that the intrinsic frequency of the damping resonator is within the frequency range.

In some embodiments, the one or more programs may be executed by the one or more processors to implement the following processes. The frequency adjustment threshold is obtained. The difference between the target resonance frequency and the frequency adjustment threshold is determined to be the lower limit, and the sum of the target resonance frequency and the frequency adjustment threshold is determined to be the upper limit. The range between the lower limit and the upper limit is determined to be the frequency range matching the target resonance frequency.

In some embodiments, the one or more programs may be executed by the one or more processors to implement the following processes. The attribute parameters include the mass parameter and the stiffness parameter. The attribute parameters of the damping resonator are adjusted, such that the intrinsic frequency of the damping resonator is within the frequency range. Based on the formula (1)

$$2 πω = \sqrt{\frac{k}{m}} ,$$

the mass parameter of the mass block and/or the stiffness parameter of the damping block are adjusted to control the intrinsic frequency of the damping resonator within the frequency range, where, k is the stiffness parameter, m is the mass parameter, and ω is the intrinsic frequency of the damping resonator.

In some embodiments, the one or more programs may be executed by the one or more processors to implement the following processes. The stiffness parameter further includes the size parameter and the hardness parameter. The stiffness parameter of the damping block may be determined based on the size parameter and the hardness parameter.

The descriptions of the embodiments of the computer-readable storage medium and the target device are similar to the descriptions of the method embodiments, and have similar beneficial effects to those of the method embodiments. For technical details not disclosed in the embodiments of the computer-readable storage medium and the target device, reference can be made to the descriptions of the method embodiments.

It should be understood that reference throughout the specification to “one embodiment” or “an embodiment” means that a particular feature, structure, or characteristic related to the embodiment is included in at least one embodiment of the present disclosure. Thus, appearances of “in one embodiment” or “in an embodiment” in various places throughout the specification are not necessarily referring to the same embodiment. Furthermore, the particular features, structures or characteristics may be combined in any suitable manner in one or more embodiments. It should be understood that, in various embodiments of the present disclosure, the sequence numbers of the above-described processes do not mean the order of execution, which should be determined by its functions and internal logic, and should not constitutes any limitation on the implementation in the embodiments of the present disclosure. The sequence numbers of the above embodiments of the present disclosure are for description only, and do not represent the advantages and disadvantages of the embodiments.

It should be noted that, in the specification, the term “comprising”, “including” or any other variation thereof is intended to cover a non-exclusive inclusion such that a process, method, article, or apparatus comprising a set of elements includes not only those elements, but also includes other elements not expressly listed, or elements inherent in the process, method, article, or device. Without further limitations, an element defined by the phrase “comprising a . . . ” does not preclude the presence of additional identical elements in the process, method, article, or apparatus comprising that element.

In the embodiments of the present disclosure, it should be understood that the disclosed devices and methods may be implemented in other ways. The device embodiments described above are only illustrative. For example, the division of units is only a logical function division. In actual implementation, there may be other division methods, such as: multiple units or components can be combined or integrated into another system, or some features may be ignored, or not implemented. In addition, the coupling, or direct coupling, or communication connection between the components shown or discussed may be through some interfaces, and the indirect coupling or communication connection of the devices or units may be electrical, mechanical, or in another form.

The units described above as separate components may or may not be physically separated, and the components displayed as units may or may not be physical units. They may be located in one place or distributed to multiple network units. Part or all of the units can be selected according to actual needs to achieve the objective of the technical solution of the embodiments of the present disclosure.

In addition, each functional unit in the embodiments of the present disclosure may be integrated into one processing unit, or each functional unit may be used as one single unit, or two or more units may be integrated into one unit. The above-described integration of the units may be realized in the form of hardware or in the form of hardware plus software functional units.

Those of ordinary skill in the art should understand that all or part of the processes to realize the above-described method embodiments may be completed by hardware executing program instructions, and the program instructions may be stored in computer-readable storage media. When being executed by a processor, the program instructions implement the processes of the above-described method embodiments. The computer-readable storage medium includes: various media capable of storing program codes such as a removable storage device, a read-only memory (ROM), a magnetic disk, or an optical disk.

Alternatively, if the above-described integrated units of the present disclosure are realized in the form of software function modules and sold or used as standalone products, they can also be stored in the computer-readable storage medium. Based on this understanding, the technical solutions of the embodiments of the present disclosure or the part that contributes to the prior art can be embodied in the form of a software product. The computer software product is stored in the computer-readable storage medium and includes program instructions for causing a computer device (which may be a personal computer, a server, or a network device, etc.) to execute all or part of the remote-control methods in various embodiments of the present disclosure. The computer-readable storage medium includes various media capable of storing program codes such as removable storage devices, ROMs, magnetic disks or optical disks.

The methods disclosed in various method embodiments provided in the present disclosure can be combined arbitrarily to obtain new method embodiments under the condition of no conflict. The features disclosed in various device embodiments provided in the present disclosure can be combined arbitrarily without conflict to obtain new device embodiments. The features disclosed in various method or device embodiments provided in the present disclosure can be combined arbitrarily without conflict to obtain new method embodiments or device embodiments.

The above description of the disclosed embodiments enables those skilled in the art to implement or use the present disclosure. Various modifications to the embodiments will be obvious to those skilled in the art, and the general principles defined herein can be implemented in other embodiments without departing from the spirit or scope of the present disclosure. Therefore, this application will not be limited to the embodiments shown in the specification, but should conform to the broadest scope consistent with the principles and novelties disclosed in the specification.

What is claimed is:

1. A target device, comprising:
a first tray located at a bottom of the target device;
at least one second tray located above the first tray; and
a damping resonator detachably installed in the first tray;
wherein a resonance frequency acquisition device is disposed in the at least one second tray configured to obtain a target resonance frequency of the target device, and the damping resonator is configured to suppress a resonance response of the target device at the target resonance frequency.

2. The target device according to claim 1, wherein:
the first tray is slidably connected to the target device through slide rails.

3. The target device according to claim 1, wherein:
the resonance frequency acquisition device includes an acceleration sensor configured to measure an acceleration over time curve of the target device, a processor configured to perform Fourier transform processing on the acceleration over time curve to obtain a power spectral density (PSD) curve, and a collector configured to collect a peak frequency on the PSD curve to obtain the target resonance frequency of the target device.

4. The target device according to claim 1, wherein:
the damping resonator includes a damping block configured to provide a stiffness parameter of the resonance damper, a mass block configured to provide a mass parameter, and a fixing elastic bar;
one end of the fixing elastic bar is fixedly attached to a bottom plate of the first tray, and another end of the fixing elastic bar is used to fix the mass block and the damping block to the first tray; and
an intrinsic frequency of the damping resonator is determined based on the stiffness parameter and the mass parameter.

5. A method for suppressing resonance response of a target device, comprising:
obtaining a target resonance frequency of the target device; and
suppressing the resonance response of the target device at the target resonance frequency through a damping resonator.

6. The method according to claim 5, further comprising after obtaining the target resonance frequency of the target device:
based on the target resonance frequency, determining a frequency range matching the target resonance frequency; and
adjusting an attribute parameter of the damping resonator to control an intrinsic frequency of the damping resonator within the frequency range.

7. The method according to claim 6, wherein determining the frequency range matching the target resonance frequency based on the target resonance frequency includes:
obtaining a frequency adjustment threshold;
determining a difference between the target resonance frequency and the frequency adjustment threshold to be a lower limit;
determining a sum of the target resonance frequency and the frequency adjustment threshold to be an upper limit; and
determining a range between the lower limit and the upper limit to be the frequency range matching the target resonance frequency.

8. The method according to claim 6, wherein:
the attribute parameter includes a mass parameter of a mass block and a stiffness parameter of a damping block; and
adjusting the attribute parameter of the damping resonator to make the intrinsic frequency of the damping resonator fall within the frequency range includes:
adjusting the mass parameter and/or the stiffness parameter according to a formula 2πω=\sqrt{k/m} to control the intrinsic frequency of the damping resonator within the frequency range, wherein, k is the stiffness parameter, m is the mass parameter, and ω is the intrinsic frequency of the damping resonator.

9. The method according to claim 8, wherein:
the stiffness parameter of the damping block further includes a size parameter and a hardness parameter; and
the stiffness parameter is determined based on the size parameter and the hardness parameter.

10. A computer-readable storage medium storing one or more programs, wherein the one or more programs are executed by one or more controllers to perform:
obtaining a target resonance frequency of a target device; and
suppressing a resonance response of the target device at the target resonance frequency through a damping resonator.

11. The computer-readable storage medium according to claim 10, wherein the one or more controllers are further configured to perform after obtaining the target resonance frequency of the target device:
based on the target resonance frequency, determining a frequency range matching the target resonance frequency; and
adjusting an attribute parameter of the damping resonator to control an intrinsic frequency of the damping resonator within the frequency range.

12. The computer-readable storage medium according to claim 11, wherein when determining the frequency range matching the target resonance frequency based on the target resonance frequency, the one or more controllers are further configured to perform:
obtaining a frequency adjustment threshold;
determining a difference between the target resonance frequency and the frequency adjustment threshold to be a lower limit;
determining a sum of the target resonance frequency and the frequency adjustment threshold to be an upper limit; and
determining a range between the lower limit and the upper limit to be the frequency range matching the target resonance frequency.

13. The computer-readable storage medium according to claim 11, wherein:
the attribute parameter includes a mass parameter of a mass block and a stiffness parameter of a damping block; and
adjusting the attribute parameter of the damping resonator to make the intrinsic frequency of the damping resonator fall within the frequency range includes:
adjusting the mass parameter and/or the stiffness parameter according to a formula
$$2 πω = \sqrt{\frac{k}{m}}$$
to control the intrinsic frequency of the damping resonator within the frequency range, wherein, k is the stiffness parameter, m is the mass parameter, and co is the intrinsic frequency of the damping resonator.

14. The computer-readable storage medium according to claim 13, wherein:
the stiffness parameter of the damping block further includes a size parameter and a hardness parameter; and
the stiffness parameter is determined based on the size parameter and the hardness parameter.
